(19) United States
(12) Patent Application Publication
(10) Pub. No.: US 2010/0104729 A1
(43) Pub. Date: Apr. 29, 2010

(54) Drinks Dispensing Apparatus

(76) Inventors: Curtis Glenn Paxman, Yorkshire (GB); Stephen John Hickson, South Glamorgan (GB)

Correspondence Address: HODGSON RUSS LLP;THE GUARANTY BUILDING, 140 PEARL STREET, SUITE 100, BUFFALO, NY, 14202-4040, US

(21) Appl. No.: 12/531,443

(22) PCT Filed: Mar. 13, 2008
(86) PCT No.: PCT/GB08/50177

§ 371 Date: Sep. 15, 2009

(30) Foreign Application Priority Data
Mar. 16, 2007 (GB) 0705095.8

(51) Int. Cl. C09K 5/06; A23L 2/00; F25D 13/00; F25D 3/00

(52) U.S. Cl. 426/590; 252/68; 62/440; 62/56

(57) ABSTRACT

A beverage cooling system comprising a beverage cooling apparatus and a coolant composition comprising a corrosion inhibitor, a freeze point depressant, and water; the apparatus comprising:—a housing comprising a reservoir;—means for freezing the coolant composition;—beverage inlet means;—a beverage cooling coil; and—beverage outlet means.

The present invention relates to an apparatus for dispensing cooled beverages, and to coolant compositions for use therewith.

The apparatus of the present invention is particularly useful for the dispensing of beer but may be used to dispense any cooled beverages, for example soft drinks and the like. Further, the apparatus could be used to deliver any cooled liquid to a locus.

A typical beer cooling apparatus is shown in FIG. 1. The apparatus comprises a container housing enclosing a reservoir which is closed by outer walls 1 and floor 2. The walls and floor are made from an insulating material. For example, the interior walls and floor may typically comprise a moulded plastic bath the outside of which is coated with an insulating material, for example a polyurethane or other foam material. The walls and floor enclose a reservoir 3 in which a coolant composition is held. Immersed in the composition are one or more coiled pipes 4 through which the beverage, for example beer may flow. The beverage enters the pipe 4 through the beverage inlet 5 and exits through the beverage outlet at 6. Because the beverage is cooled by passage through the coil immersed in the cooling composition, the temperature of the beverage leaving the apparatus from outlet 6 is lower than the temperature of the beverage entering the apparatus at inlet 5. When the beverage is beer, the supply inlet may be connected to a barrel stored in a cellar for example at 10-12° C. Alternatively a barrel of beer may be stored at ambient temperature. For many traditional beers, a desirable serving temperature is about 6° C.

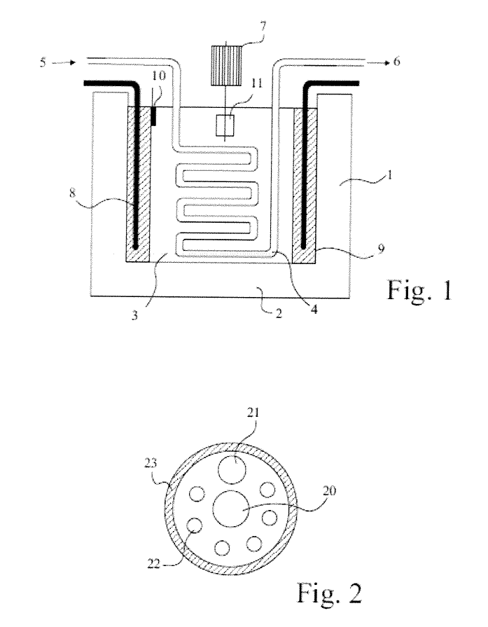

From the outlet pipe the beverage may be delivered to a dispensing point in a bar or other location along a beverage dispensing tube. Because the dispensing point may be a long way from the cooling apparatus, for example in a large bar or club, the dispenser tube is typically encapsulated within an outer casing along with a cooling tube. The cooling tube carries coolant composition from the apparatus to the vicinity of the dispensing point. A coolant return tube returns the coolant composition to the reservoir. Such a delivery system is known to those skilled in the art as a python or trunkline system and is shown in cross-section in FIG. 2. Cooling tube 20 carries the coolant composition from the cooling apparatus to the dispensing point and it returns along coolant return tube 21. Around cooling tube 20 are a plurality of beverage dispensing tubes 22 enclosed within outer insulating casing 23. Each dispensing tube is connected via a different outlet 6 to a different coiled pipe 4. Thus, a plurality of coiled pipes may be immersed in the reservoir at any one time and the apparatus may be used to cool a plurality of beverages simultaneously. This is typically the case in a bar where a number of different cooled beers may be delivered to a plurality of taps.

Thus by a heat exchange mechanism, the cooling composition may be required to cool a plurality of beverages contained within cooling coils immersed in the reservoir as well as during delivery to the dispensing point in cooling tube 20/return tube 21. Cooling tube 20 (not shown in FIG. 1) is supplied with coolant composition from the reservoir via a pump in motorised unit 7. During this procedure the coolant composition that runs to the bar and back may substantially increase in temperature and thus will increase the temperature of the coolant composition in the reservoir. The temperature of the coolant composition is also increased by heat exchange with cooling coils 4. It is therefore desirable that the coolant composition within the reservoir is initially at a low temperature which can be maintained. In a busy bar where drinks are continually delivered, the beverage will only sit in the coils immersed in the coolant composition for a short period. In a quiet bar the beverage may be in the dispensing tube leading from the coolant apparatus tank to the bar for long periods and thus it is desirable that the coolant composition in the reservoir and in the cooling tube and coolant return tube is as cool as possible to maintain the low temperature.

In known beer cooling apparatus, water is typically used as the coolant composition. An advantage of water is that it readily freezes to form ice. Cooling of the coolant composition is via refrigeration pipes 8 which are located within the inside edges of reservoir walls 1. Ice banks 9 build up around the refrigeration units when they are in use. It is necessary that the ice does not become too thick and cause the whole reservoir to freeze, as immersion of coils 4 in a solid coolant composition would provide insufficient heat exchange and could lead to problems with the pipes cracking, or with the beverage freezing. A switch 10 is therefore provided at the desired outer edge of the ice bank. The switch may, for example, be in the form of a thermostat, or it may be an ice bank controller which measures the difference in resistance between two points, and is known to those skilled in the art. When the ice reaches the switch the refrigeration unit is turned off and as the ice begins to melt it is turned back on again. This means that the apparatus is quite energy efficient as the refrigeration unit is only using power when necessary, and the ice banks help maintain the liquid coolant composition at the desired temperature. The water within the reservoir is maintained in circulation by means of motor 11 connected to motorised unit 7, which also houses the pump. The motor ensures that the water circulates and also causes small particles of ice to become disengaged from the side of the ice bank. These float around the coolant composition and melt within it, maintaining a low temperature.

A disadvantage of using water is however that the minimum temperature at which the cooling composition can be maintained at is 0° C. Whilst this is suitable for cooling traditional beers to 6° C., in recent years there has been increased demand for “extra cold” beers and the like. Further, in warmer countries it is often desirable to serve very cold drinks and in some cases beverages cannot be stored in a cold cellar. In addition, if the dispensing point is located quite far from the cooling apparatus, the circulation of coolant composition in the cooling tube and coolant return tube may lead to a significant rise in temperature. Thus it would be desirable to provide a coolant composition which can be maintained in a reservoir at temperatures below 0° C.

A solution offered by the prior art which provides a composition which may be maintained at a lower temperature is to add an amount of a glycol compound, for example monopropylene glycol, to water. The addition of glycol prevents water freezing at 0° C. and thus a coolant composition comprising water and glycol can be maintained at temperatures below 0° C. In such coolant compositions of the prior art, the coolant has been used in liquid form and has not been used to form ice banks. The present inventors attempted to form ice banks from glycol containing compositions but found that such compositions do not readily allow ice banks to form around the edge of the cooling tank. The material which forms when a composition comprising water and the required amount of glycol is cooled is not crystalline ice but a slushy material which is inadequate. Consequently firm ice banks do not build up around the edge of the reservoir.

Other proposed solutions to the problem of providing colder beer have included using additional “mini coolers” through which the beverage passes on the way to the dispensing point. However, this is again very energy and cost inefficient.

The present invention seeks to overcome at least one of the disadvantages of the prior art and in particular seeks to provide a coolant composition which is able to freeze at a temperature of below 0° C.

According to a first aspect of the present invention there is provided a coolant composition for use in beverage dispense apparatus, said composition comprising:

(a) a freeze point depressant;

(b) a corrosion inhibitor; and

(c) water;

wherein the composition has a freezing point of below 0° C. and solidifies to form firm ice banks of substantially uniform structure.

The ice banks formed by the composition of the present invention are superior to those of the prior art because they are firm and well structured. They suitably have a similar physical structure to an ice cube. As detailed above, ice banks made from compositions containing glycol are poorly structured. Any ice banks which do form crumble around the edges: they are not firm to the touch. The ice banks of the present invention are suitably hard whereas those formed by glycol-containing solutions are much softer. The ice banks formed by the composition of the present invention have also been found to retain their structure for longer periods.

When the compositions of the present invention are used in the beer cooling apparatus as described above in relation to FIG. 1, and the motor is switched on, circulation within the liquid causes particles of ice to become dislodged from the surface of the ice bank and circulate within the liquid composition. Dissolution of these solid particles helps maintain the low temperature of the liquid composition and aids efficient heat exchange. The structure of the ice banks of the present invention ensures that uniform wash off the ice banks into the liquid is achieved and well-structured crystalline particles are dispersed throughout. In contrast, any ice which forms when using glycol-based solutions tends to break down poorly when the liquid is agitated using a motor leading to clumps of slushy material which dissolve poorly.

Component (a) is suitably a compound which when present in the composition enables it to freeze at a temperature lower than the temperature at which pure water freezes. Suitably the combination of component (a) with component (b) results in a desired freeze point depression. Suitably component (a) comprises a water soluble salt, preferably of an alkali metal, or an ammonium or substituted ammonium salt. Preferably component (a) comprises a salt of an organic acid.

According to a second aspect of the present invention there is provided a coolant composition for use in beverage dispense apparatus, the composition comprising:
(a) a freeze point depressant selected from one or more carboxylic acid salts;
(b) a corrosion inhibitor; and
(c) water.

The first and second aspects may be regarded as alternative definitions of the same invention. The following definitions of preferred features of the invention apply equally to both aspects.

Preferably the composition of the second aspect freezes to form ice banks as defined in relation to the first aspect.

Component (a) is preferably the salt of an aliphatic or aromatic carboxylic acid having up to 20 carbon atoms. Preferably it is a salt of an aliphatic carboxylic acid, preferably having up to 15, more preferably up to 12 or up to 10 carbon atoms.

Suitably component (a) comprises the salt of an aliphatic organic acid having 1 to 8 carbon atoms and 1 to 3 carboxylic acid residues. When more than one carboxylic acid residue is present, the salt may be a monosalt, or a disalt or a trisalt. Where more than one cationic counterion is present, these may be the same or different or in some cases may comprise a polyvalent cation.

The organic acid may be substituted, for example it may include hydroxyl substituents. Preferably it is unsubstituted. Preferably component (a) includes only a single acid moiety. Most preferably component (a) comprises an organic acid having 1 carboxylic acid group and 1 to 4 carbon atoms. Preferably component (a) is a sodium or potassium salt of an organic acid having 1 or 2 carbon atoms. Most preferably it is potassium formate.

The corrosion inhibitor (b) may also act as a freeze point depressant and is present in addition to the other freeze point depressant material (a).

Components (a) and (b) may be regarded as acting synergistically to provide a desired depression of the freeze point.

Preferably component (a) is present in the composition of the present invention an amount of at least 0.1 gdm⁻³, more preferably at least 0.5 gdm⁻³ and most preferably at least 1 gdm⁻³.

Component (a) may be present in an amount of up to 10 gdm⁻³, for example up to 5 gdm⁻³, or up to 2 gdm⁻³. Preferably, however, component (a) is present in a greater amount.

It is a feature of the present invention that the temperature at which the composition of the present invention freezes may be varied by varying the amount of component (a) present in the composition. Preferably component (a) is present in the composition in an amount of from 5 to 30 gdm⁻³ for each 1° C. depression of the freezing point. The freezing point depression is measured with respect to pure water. Thus if it is desired to depress the freezing point by 1° C., from 5 to 30 gdm⁻³ of component (a) is added; for a depression of 2° C., from 10 to 60 gdm⁻³ of component (a) is added, and so on.

Suitably component (a) is present in an amount of from 10 to 25 gdm⁻³ for each ° C. depression of the freezing point, preferably from 12 to 22 gdm⁻³.

The composition is an aqueous composition. Thus depression of the freezing point of the composition refers to depression of the freezing point of water. Hence a depression of 3° C. will lead to a composition which freezes at −3° C.

In one preferred embodiment of the present invention a composition which freezes at −2° C. is provided which comprises from 5 to 50 gm⁻³ of component (a) preferably from 10 to 40 gdm⁻³, more preferably 20 to 35 gdm⁻³, more preferably from 25 to 35 gdm⁻³.

In a preferred embodiment which freezes at −3° C., component (a) is present in an amount from 20 to 70 gdm⁻³, more preferably 30 to 60 gdm⁻³ and more preferably from 40 to 50 gdm⁻³.

In an embodiment which freezes at −4° C., component (a) is preferably present in an amount of from 60 to 100 gdm⁻³, preferably from 70 to 90, more preferably from 75 to 85 gdm⁻³.

In an embodiment which freezes at −5° C., component (a) is preferably present in an amount from 75 to 120 gdm⁻³, preferably from 85 to 110 gdm⁻³, more preferably from 95 to 105 gdm⁻³.

It has been surprisingly found that compositions which freeze at a temperature of as low as −5° C. freeze to form ice banks of substantially uniform structure. It is also possible to provide compositions which freeze to form ice banks at lower temperatures.

Component (b) may include any suitable corrosion inhibitor. Examples of compounds suitable for use as corrosion inhibitors include hexamine, phenylenediamine, dimethylethanolamine, cinnamaldehyde, condensation products of aldehydes and amines (imines), chromates, nitrites, phosphates, phosphonates, sodium benzoate, sodium triazoles and organic acids.

Preferred corrosion inhibitors for use in the present invention are phosphate compounds, in particular ammonium, substituted ammonium or alkali metal salts of phosphoric acid. One or more cationic counterions may be present.

Preferably component (b) comprises a salt of phosphoric acid with sodium and/or potassium. Most preferably component (b) comprises dipotassium phosphate.

In some embodiments component (b) comprises a mixture of corrosion inhibitors. Preferably however dipotassium phosphate is the major corrosion inhibitor present. Other corrosion inhibitors, where present, are present in minor amounts compared with dipotassium phosphate, for example less than 10% by weight. Suitably dipotassium phosphate is the only corrosion inhibitor present. When component (b) comprises two or more corrosion inhibitors, these compounds preferably act synergistically. In some embodiments, component (b) further comprises a heterocyclic corrosion inhibitor. Preferred are nitrogen-containing heterocyclic compounds.

Component (b) may comprise an aromatic heterocyclic corrosion inhibitor. Most suitable are azole compounds, especially triazoles. Examples include benzatriazoles, and substituted benzatriazoles, especially tolutriazole. However, in preferred embodiments, the composition does not include an aromatic heterocyclic corrosion inhibitor.

Component (b) may comprise an organic acid. Preferred organic acids include those having 1 to 10, preferably 1 to 6 carbon atoms, and 1 to 3 carboxylic acid residues. Most preferred are organic acids having 1 to 3 carbon atoms and one carboxylic acid group. Component (b) may comprise an organic acid selected from formic acid, acetic acid and a mixture thereof.

Component (b) is preferably present in an amount of at least 0.5 gdm⁻³, preferably at least 1 gdm⁻³, preferably at least 2 gdm⁻³, more preferably at least 3 gdm⁻³, and most preferably at least 4 gdm⁻³. Component (b) is preferably present in an amount of up to 50 gdm⁻³, preferably up to 25 gdm⁻³, more preferably up to 15 gdm⁻³, preferably up to 10 gdm⁻³, and most preferably up to 7 gdm⁻³.

The above concentrations refer to the total amount of component (b) in the composition and include all of the corrosion inhibitors present in the composition.

When component (b) includes an alkali metal phosphate, this is preferably present in an amount of up to 20 gdm⁻³, preferably up to 8 gdm⁻³, more preferably up to 6 gdm⁻³. The alkali metal phosphate, when present, is suitably present in an amount of at least 1 gdm⁻³, preferably at least 2.5 gdm⁻³, more preferably at least 4 gdm⁻³.

When component (b) includes an aromatic heterocyclic corrosion inhibitor, this is preferably present in an amount of less than 100 mgdm⁻³, preferably less than 50 mgdm⁻³, more preferably less than 30 mgdm⁻³. It is suitably present in an amount of at least 1 mgdm⁻³, preferably at last 5 mgdm⁻³, more preferably at least 10 mgdm⁻³.

When component (b) includes one or more organic acids, these are present in an amount of up to 1 gdm⁻³, preferably up to 0.5 gdm⁻³, more preferably up to 0.3 gdm⁻³. They are suitably present in an amount of at least 0.05 gdm⁻³, preferably at least 0.1 gdm⁻³, more preferably at least 0.2 gdm⁻³.

Suitably the ratio of component (a) to component (b) may be varied to control the temperature at which the composition freezes. This is usually achieved by varying the amount of component (a).

Preferably component (a) and component (b) together comprise at least 50 wt % of all solids dissolved in the composition of the present invention, more preferably at least 70 wt %, preferably at 90 wt %, preferably at least 95 wt %, for example at least 97 wt %.

Optionally the cooling composition of the present invention may comprise further components.

In some embodiments, the composition of the present invention may further comprise a deposit combatant. The deposit combatant may comprise a single chemical moiety or it may include a mixture of compounds. The term deposit combatant hereinafter refers to the total amount of all such compounds.

The term deposit combatant includes antiscalant compounds. This term includes dispersant compounds. Suitable combatants may act as an antiscalant and a dispersant. These are preferably compound(s) which are able to sequester certain cations, for example magnesium and calcium to maintain them in solution and prevent deposits building up on the internal surfaces of the apparatus. Any suitable sequestering agent may be used as a deposit combatant.

Examples of suitable deposit combatants include phosphonate chelating agents, amino carboxylate chelating agents, other carboxylate chelating agents, polyfunctionally-substituted aromatic chelating agents, ethylenediamine N,N′-disuccinic acids, or mixtures thereof.

Suitable phosphonate chelating agents may include mono-phosphates, di-phosphates, tri-polyphosphates or oligomeric-polyphosphates. Examples of phosphonates include sodium tripolyphosphate (STPP), alkali metal ethane 1-hydroxy diphosphonates (HEDP) also known as ethydronic acid, alkylene poly (alkylene phosphonate), as well as amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP). The phosphonate compounds may be present either in their acid form or as salts of different cations on some or all of their acid functionalities. Such phosphonate chelating agents are commercially available from Monsanto under the trade name DEQUEST®.

Polyfunctionally-substituted aromatic chelating agents may also be useful as deposit combatants. Suitable compounds of this type in acid form include dihydroxydisulfobenzenes such as 1,2-dihydroxy-3,5-disulfobenzene.

Suitable biodegradable chelating agents for use as a deposit combatant include ethylene diamine N,N′-disuccinic acid, or alkali metal, or alkaline earth, ammonium or substitutes ammonium salts thereof or mixtures thereof.

Tetrasodium imminosuccinate may also be used as a deposit combatant.

Suitable amino carboxylates include ethylene diamine tetra acetates, diethylene triamine pentaacetates, diethylene triamine pentaacetate (DTPA),N-hydroxyethylethylenediamine triacetates, nitrilotri-acetates, ethylenediamine tetrapropionates, triethylenetetraaminehexa-acetates, ethanol-diglycines, propylene diamine tetracetic acid (PDTA), glutamic-N,N-diacetic acid (GLDA) and methyl glycine di-acetic acid (MGDA), both in their acid form, or in their alkali metal, ammonium, and substituted ammonium salt forms.

Other suitable carboxylate chelating agents to be used include salicylic acid, aspartic acid, glutamic acid, glycine, malonic acid or mixtures thereof.

Useful deposit combatants include organic molecules containing carboxylic groups for example citric acid, fumaric acid, tartaric acid, maleic acid, lactic acid and salts thereof. In particular the alkali or alkaline earth metal salts of these organic compounds may be used, and especially the sodium salts. One suitable compound is sodium citrate.

Other suitable deposit combatants include aspartic acid-N-monoacetic acid (ASMA), aspartic acid-N,N-diacetic acid (ASDA), aspartic acid-N- monopropionic acid (ASMP), iminodisuccinic acid (IDA), N-(2-sulfomethyl)aspartic acid (SMAS), N-(2-sulfoethyl)aspartic acid (SEAS), N-(2-sulfomethyl)glutamic acid (SMGL), N-(2-sulfoethyl)glutamic acid (SEGL), N-methyliminodiacetic acid (MIDA), α-alanine-N,N-diacetic acid (α-ALDA), β-alanine-N,N-diacetic acid (β-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and sulfomethyl-N,N-diacetic acid (SMDA) and alkali metal salts or ammonium salts thereof.

Preferred deposit combatants include homopolymers and copolymers of polycarboxylic acids and their partially or completely neutralized salts, monomeric polycarboxylic acids and hydroxycarboxylic acids and their salts, phosphates and phosphonates, and mixtures of such substances. Preferred salts of the abovementioned compounds are the ammonium and/or alkali metal salts, i.e. the lithium, sodium, and potassium salts, and particularly preferred salts is the sodium salts.

Suitable polycarboxylic acids are acyclic, alicyclic, heterocyclic and aromatic carboxylic acids.

The deposit combatant most preferably comprises a polymer of acrylic acid or a salt thereof. Preferably it comprises a polyacrylate compound. Preferably the deposit combatant comprises a sodium polyacrylate. Suitable polyacrylates are those having a molecular weight of from 200 to 25000, preferably from 500 to 10000, for example 800 to 5000 or 1000 to 3000. Preferred deposit combatants include those sold by Cytec, for example under the trade mark Cytec P70. Suitably such compounds have been approved for use in drinking water.

The deposit combatant is preferably present in the composition of the present invention in an amount of at least 1 mgdm⁻³, preferably at least 5 mgdm⁻³, more preferably at least 8 mgdm⁻³, and most preferably at least 10 mgdm⁻³. The deposit combatant is preferably present in the coolant composition of the present invention in an amount of up to 50 mgdm⁻³, preferably up to 30 mgdm⁻³, more preferably up to 20 mgdm⁻³, and most preferably up to 15 mgdm⁻³.

The composition may include a component having antimicrobial properties. This may be provided by component (a). For example potassium formate has antimicrobial properties.

Alternatively, the composition may include an additional antimicrobial component. For example it may include a biocide.

Any suitable biocide may be used. Preferred biocides are inhibitors of for example pseudomonas, legionella, algae and the like. Suitable biocides include polymeric biocides, in which the active biocidal entity is immobilised on a polymeric backbone. The biocide may be a hydrophobic material.

Examples of polymeric biocide materials include biguanide antimicrobial agents. One suitable polymeric biguanide compound is polyhexamethylenebiguanide (PHMB), or derivatives thereof.

Preferred biocides for use in the composition of the present invention include those sold under the trade mark Watersafe, available from Sensitive Water Solutions Limited.

Other preferred biocides include isothiazoline and derivatives thereof and tetrakishydroxymethylphosphorium sulfate (THPS).

The biocide is preferably present in a non-toxic amount.

The biocidal component may be present in an amount of at least 0.5 mgdm⁻³, for example at least 1.0 mgdm⁻³, at least preferably 2 mgdm⁻³, or at least 2.5 mgdm⁻³.

The biocidal component is preferably present in an amount of up to 200 mgdm⁻³, preferably up to 150 mgdm⁻³, more preferably up to 100 mgdm⁻³, preferably up to 80 mgdm⁻³, and most preferably up to 60 mgdm⁻³.

In some embodiments, the biocide may be present in an amount of from 25 to 70 mgdm⁻³, for example from 55 to 65 mgdm⁻³.

In an alternative embodiment, the biocide may be present in an amount of from 0.1 to 20 mgdm⁻³, for example from 1 to 10 or 3 to 7 mgdm⁻³.

Each of components (a) and (b), the deposit combatant and the antimicrobial agent may be present as a mixture of two or more components as defined in relation thereto.

Component (c) is water. Suitably it is very pure water which has been de-ionised or distilled. Tap water is not preferred as it contains to many dissolved species that would lead to the formation of solid residues in the form of scale or scum. To avoid this, large quantities of deposit combatants could be added but this is not preferred. Chlorine residues are also commonly found in tap water and are undesirable. In a preferred embodiment the water used in the composition of the present invention is soft water which has been passed through a carbon filter, a reverse osmosis membrane and a cationic resin bed. Alternatively it may be passed through an ion exchange resin. The water may also be treated with ultra violet radiation to counter biological contaminants.

Preferably the composition of the present invention comprises components (a) and (b), optionally a deposit combatant and/or a biocide in a total mass of from 5 to 200 g, more preferably from 20 to 170 g, most preferably 35 to 150 g, per dm³.

In one preferred embodiment, the coolant composition of the present invention comprises:
(a) a freeze point depressant;
(b) a corrosion inhibitor;
(c) a deposit combatant;
(d) an antimicrobial agent; and
(e) water.

In one embodiment, the composition consists essentially of a corrosion inhibitor, a deposit combatant, a biocide, a freeze point depressant and water.

In a further embodiment, the composition of the present invention comprises:

(i) from 3 to 7 gdm⁻³, for example 4.5 to 5.5 gdm⁻³ dipotassium phosphate;

(ii) from 1 to 30 mgdm⁻³, for example 5 to 15 mgdm⁻³ polyacrylate;

(iii) from 20 to 80 mgdm⁻³, for example 45 to 55 mgdm⁻³ biocide;

(iv) from 0.5 to 150 gdm⁻³, for example 20 to 60 gdm⁻³ potassium formate; and

(v) water.

Suitably each component of the composition of the present invention is non-toxic when present at the concentrations used. The components may be of food grade and may suitably have been approved for food contact use.

Preferably the composition of the present invention has a refractive index of from 1.2 to 1.5, more preferably from 1.3 to 1.4.

There may be a pH buffer present. A pH buffer may be present as an additional component. However, component (b) may also act as a pH buffer, or part of a buffer system. Preferably component (b) acts as a buffering agent.

Preferably the composition has a pH of between 6 and 12, preferably between 7 and 10, for example between 8 and 9. Most preferably the pH is about 8.5.

Preferably the composition of the present invention freezes at a temperature of below 0° C., preferably at a temperature of below −0.5° C., preferably below −1° C., more preferably below −1.5° C. In some embodiments the composition may freeze at a temperature of less than −2° C., for example less that −3° C., less that −4° C. or less than −5° C.

Suitably the composition of the present invention freezes at a temperature of between 0 and −15° C., for example between −0.5° C. and −10° C., preferably between −1° C. and −8° C., for example between −1.5° C. and −6° C., suitably between −2° C. and −5° C. It may freeze at a temperature of between −1° C. and −4° C., for example between −2° C. and −2.5° C.

As detailed above, the temperature at which the composition freezes may be varied by varying the amount of one or more of the components, in particular component (a) present in the composition.

The freezing points referred to herein are as measured at standard atmospheric pressure (1.013×10⁶ Pa).

As described above, the composition of the present invention preferably freezes to form a solidified structure which is substantially uniform, crystalline and firm to the touch. Contact of ice-banks formed from this material with a liquid phase thereof may facilitate enhanced cooling of the liquid phase.

The present invention further provides a firm ice bank having a substantially uniform structure formed from a composition of the first and second aspect.

Ice banks are formed by removing the heat of fusion from the liquid composition. The heat of fusion is the thermal energy which must be removed from a liquid in order for it to undergo a phase change to form a solid. Once the energy has been removed (via the refrigeration units), the ice banks act as a “coldness” store. An equivalent amount of energy to the heat of fusion must be supplied in order to melt the ice. Thus, the higher the enthalpy of fusion, the more heat energy is needed to melt the ice. Heat energy is removed from a beverage as it is cooled on passing through the apparatus of the present invention. This energy is absorbed by the liquid/ice system and induces melting of the ice.

The ice banks of the present invention have been found to have a higher enthalpy of fusion that ice banks formed from monopropylene glycol based compositions and thus a larger quantity of beverage may be cooled before the ice melts. Thus a longer period elapses before the refrigeration unit needs to be switched back on to restore the ice banks. Typically the refrigeration unit will be switched on before substantial melting of the ice banks has occurred.

The present inventors have therefore found that less electricity is used when using coolant compositions of the present invention compared with coolant compositions based on monopropylene glycol.

For ice banks formed from composition of the present invention which freeze between −1° C. and −3° C., for example at about at −2° C., the enthalpy of fusion is preferably at least 100 kJ/kg, more preferably at least 120 kJ/kg, for example at least 140 kJ/kg.

The composition of the first or second aspect may suitably be provided in dilute ready to use form. Alternatively it may be provided in concentrate form.

According to a third aspect of the present invention, there is provided a coolant composition concentrate for use in dispense apparatus, which upon dilution forms a coolant composition according to the first or second aspect.

Suitably the coolant composition concentrate of the third aspect is supplied with instructions to inform the user how to prepare a composition of the first or second aspect.

According to a fourth aspect of the present invention, there is provided a beverage cooling system comprising a beverage cooling apparatus and a coolant composition comprising a freeze point depressant, a corrosion inhibitor and water; the apparatus comprising:
a housing comprising a reservoir;
means for freezing the coolant composition;
beverage inlet means;
a beverage cooling coil; and
beverage outlet means.

The coolant composition is preferably as defined in relation to the first or second aspect.

The coolant composition is suitably stored in the reservoir of the apparatus. The beverage may enter the cooling coil via the beverage inlet means and exit via the beverage outlet means. The beverage may be suitably supplied to the beverage inlet means from a storage tank (e.g. barrel of beer) and may be delivered from the beverage outlet means to a dispensing point (e.g. bar). The means for freezing a coolant composition is suitably a traditional refrigeration unit located adjacent the interior walls of the housing and controlled by a switch, for example a thermostat.

The apparatus may also further comprise means for agitating the coolant composition located within the reservoir.

The apparatus of the system of the fourth aspect of the present invention is preferably a standard apparatus of the prior art. Thus the coolant composition of the first or second aspect of the present invention may be used with any existing coolant apparatus which uses pure water without significant modification of said apparatus.

According to a fifth aspect of the present invention there is provided a method of cooling a beverage, the method comprising passing the beverage through a pipe immersed in a composition of the first or second aspect. Preferably in the method of the fifth aspect the composition is at a temperature of below 0° C., for example below −1° C., preferably below −1.5° C., for example −2° C. It may be at a temperature of below −2.5° C., −3° C. or −4° C., for example −5° C. Suitably the method of the fifth aspect is carried out using the system of the third aspect.

According to a sixth aspect of the present invention there is provided the use of a coolant composition as defined in relation to the first or second aspect to cool a beverage.

According to a seventh aspect of the present invention there is provided a beverage cooled by the method of the fifth aspect. Suitably the beverage may be cooled to a temperature of below 6° C., preferably below 5° C., for example about 4° C. or about 3° C. In some embodiments, a beverage may be cooled to a yet lower temperature, for example about 2° C. or 1° C.

The invention will now further described by way of the following non-limiting examples.

### EXAMPLE 1

A 1000 litre batch of a composition of the present invention was prepared comprising the following:
30 kg potassium formate
5 kg dipotassium phosphate
12.6 g Cyanamer P70 polyacrylate
981 kg ultra pure water

Ultra pure water is soft water which has been passed through a carbon filter, a reverse osmosis membrane, a cationic resin bed and UV filter.

60 litres of the composition were placed in a standard line cooling beer cooling apparatus and the refrigeration units were turned on. The temperature of the composition was maintained at −2° C., and the ice bank formation was controlled by means of a thermostat.

A sample of beer having an alcohol strength of 4.2% by volume and an initial temperature of 12° C. was passed through the apparatus at a rate of 5 pints per minute, and delivered via a 30 m python delivery tube. It was found to have a temperature of 4° C.

Such a test is intended to replicate a very busy trading outlet at peak periods and is used as a benchmark test in the industry.

The above composition freezes at −2° C. to form firm banks of ice having a substantially uniform crystalline structure.

The enthalpy of fusion associated with the formulation of these ice banks was found to be 150 kJ/kg. For an aqueous composition comprising 7% by volume of monopropylene glycol, the enthalpy of fusion at −2° C. was found to be −75 kJ/kg.

### EXAMPLE 2

A 1000 litre batch of a composition of the present invention was prepared comprising:
99 kg potassium formate
5 kg dipotassium phosphate
12.6 g cyanamer P70 polyacrylate.
946.5 kg ultra pure water.

The composition freezes at −5° C. to form firm blocks of ice having a substantially uniform crystalline structure.

### EXAMPLE 3

An experiment was carried out to compare the running costs of a composition of the present invention and a glycol-containing solution.

A beer cooling apparatus operated by a 21 cc compressor connected to a 25 i m python system at an ambient temperature of 23.6° C. was filled, successively, with the composition of example 1, an aqueous composition comprising 7% by volume of monopropylene glycol and finally water. Tests were carried out to measure compressor usage and recirculation temperatures. The beer cooling apparatus was in turn filled with the three liquids and held at 9.4° C. before starting the tests.

The apparatus was then switched on and recordings were taken of the recirculation temperature, both flow and return, the central bath area and the temperature of the liquid close to the ice. The compressor was also monitored for service. No product was dispensed during these trials.

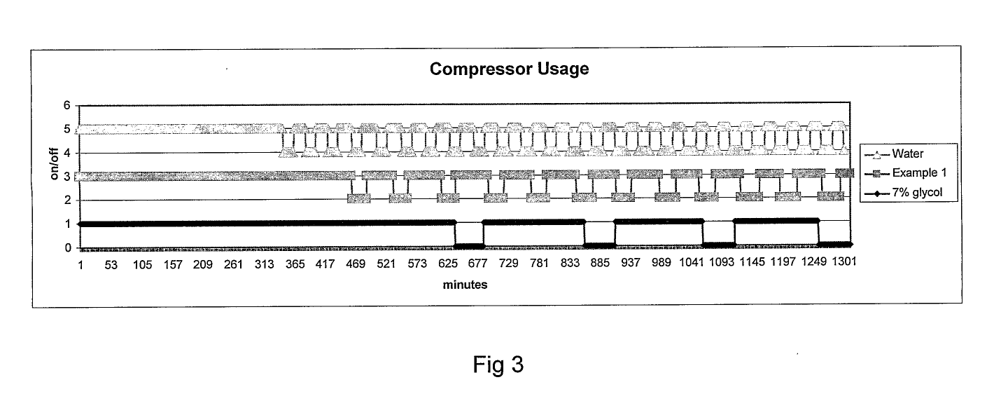

A graph of the results obtained is shown in FIG. 3.

FIG. 3 shows when the compressor was using power during tests carried out over 21 hours. The composition of example 1 reached an operating temperature of −2° C. in 7 hours and 43 minutes whereas the glycol based composition required 10 hours and 38 minutes. This can be compared to water, which is the optimum coolant option but cannot achieve the lower temperatures, where freezing occurred after 5 hrs and 47 minutes.

A significant test of energy efficiency is the length of time the compressor is not running over a period of time.

The results shown in FIG. 3 reveal that for the composition of example 1, the compressor is in operation for 65% of the time; whereas for the 7% v/v monopropylene glycol composition, the compressor is in operation for 78% of the time.

Assuming a similar usage cycle is observed when using a 34 cc compressor which operates at 1 KW, if a unit of electricity costs 10 pence, then it can be calculated that a saving of £226.36 annually could be obtained by using a composition of the present invention rather than a composition comprising 7% v/v monopropylene glycol.

Savings would increase if the apparatus is used to cool a beverage.

It is also necessary to consider these compositions compared with water so that the cost of obtaining colder beer can be calculated. A benefit of using a composition of the present invention to cool beer to a lower temperature in the cellar is that it allows a user to remove secondary cooling powered by compressors under the bar. Thus overall there may be a energy cost saving by taking out the under counter cooling.

However considering only cellar cooling, it can be calculated based on the results shown in FIG. 3 that changing from water to a lower temperature ice bath would raise the energy costs associated with cooling beer by the following:

Composition of the present invention—7% increase

7% v/v monopropylene glycol solution—28% increase.

1. A coolant composition for use in beverage dispense apparatus, said composition comprising:
(a) a freeze point depressant;
(b) a corrosion inhibitor; and
(c) water;
wherein the composition has a freezing point of below 0° C. and solidifies to form firm ice banks of substantially uniform structure.

2. A coolant composition of claim 1
wherein the freeze point depressant comprises one or more carboxylic acid salts.

3. A composition according to claim 1 wherein the freeze point depressant comprises the salt of an aliphatic organic acid having 1 to 8 carbon atoms and 1 to 3 carboxylic acid residues.

4. A composition according to claim 3, wherein the freeze point depressant comprises potassium formate.

5. A composition according to claim 1, wherein component (a) is present in an amount of from 5 to 30 gdm−3 for each 1° C. depression of the freezing point achieved, compared to water.

6. A composition according to claim 1 wherein the corrosion inhibitor comprises dipotassium phosphate.

7. A composition according to claim 1 which further comprises a deposit combatant.

8. A composition according to claim 1 which further comprises an antimicrobial agent.

9. A composition according to claim 1 which further comprises:
(d) a deposit combatant; and
(e) a biocide.

10. A composition according to claim 1 which has a pH of between 7 and 10.

11. A composition according to claim 1 which freezes at a temperature of between 0 and −10° C.

12. (canceled)

13. A beverage cooling system comprising a beverage cooling apparatus and a coolant composition comprising a freeze point depressant, a corrosion inhibitor and water; the apparatus comprising:
a housing comprising a reservoir;
means for freezing the coolant composition;
beverage inlet means;
a beverage cooling coil; and
beverage outlet means.

14. A method of cooling a beverage, the method comprising passing the beverage through a pipe immersed in a composition as claimed in claim 1.

15. (canceled)

16. (canceled)
